(19) United States
(12) Patent Application Publication
(10) Pub. No.: US 2019/0163338 A1
(43) Pub. Date: May 30, 2019

(54) PAGE DISPLAY DEVICE AND PAGE DISPLAY METHOD

(71) Applicant: FUJITSU LIMITED, Kawasaki-shi (JP)

(72) Inventor: AYA TAKASUGI, Kawasaki (JP)

(73) Assignee: FUJITSU LIMITED, Kawasaki-shi (JP)

(21) Appl. No.: 16/262,090

(22) Filed: Jan. 30, 2019

Related U.S. Application Data
(63) Continuation of application No. PCT/JP2016/072567, filed on Aug. 1, 2016.

(51) Int. Cl. G06F 3/0485

(52) U.S. Cl. CPC G06F 3/0485

(57) ABSTRACT

A computer-readable non-transitory recording medium storing a program that causes a computer to execute a procedure, the procedure includes invalidating a scroll function for receiving a scroll operation on a content, in a case where the content included in a display target page includes the scroll function and a width or a height of a display area of the content or a ratio of the width or the height of the content to a screen displaying the display target page is in a predetermined state, and displaying the display target page on the screen in a state of receiving an operation request for the content.

### CROSS-REFERENCE TO RELATED APPLICATION

This application is a continuation application of International Application PCT/JP2016/072567 filed on Aug. 1, 2016 and designated the U.S., the entire contents of which are incorporated herein by reference.

### FIELD

The present invention relates to a page display device and a page display method.

### BACKGROUND

In recent years, mobile terminal devices that may be operated by using a touch panel are increasing, such as smart phones, tablets, car navigation devices, and the like.

FIG. 1 illustrates an example of a display screen of such a mobile terminal device. For example, in the case of scrolling up and down a content 101 included in a web page displayed on a screen, as indicated by an arrow 103, a user performs a scroll operation of sliding up and down the screen with a finger 102. As a result, the user may browse information such as desired text and images included in the content 101.

There is also known a page display method of superimposing one page content on another page content by using a “canvas” tag (see, for example, Japanese Laid-open Patent Publication No. 2014-109987).

### SUMMARY

According to an aspect of the invention, a computer-readable non -transitory recording medium storing a program that causes a computer to execute a procedure, the procedure includes invalidating a scroll function for receiving a scroll operation on a content, in a case where the content included in a display target page includes the scroll function and a width or a height of a display area of the content or a ratio of the width or the height of the content to a screen displaying the display target page is in a predetermined state, and displaying the display target page on the screen in a state of receiving an operation request for the content.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a display screen of a mobile terminal device;

FIG. 2 is a diagram illustrating a content embedded in a web page;

FIG. 3 is a diagram illustrating a scroll operation on the web page;

FIG. 4 is a diagram illustrating a display screen to which a scroll bar is added;

FIG. 5 is a diagram illustrating a display screen to which a non -display button is added;

FIG. 6 is a diagram illustrating a display screen with a size of a map content limited;

FIG. 7 is a functional configuration diagram of a page display device;

FIG. 8 is a flowchart of page display processing;

FIG. 9 is a functional configuration diagram illustrating a specific example of the page display device;

FIG. 10 is a diagram illustrating an operation of displaying the map content on another page;

FIG. 11 is a diagram illustrating an operation of scrolling the map content;

FIG. 12 is a diagram illustrating sizes of the screen and an internal content;

FIG. 13 is a flowchart illustrating a specific example of page display processing;

FIG. 14 is a flowchart of first operation event invalidation processing;

FIG. 15 is a diagram illustrating first conversion processing in a case where there is an “iframe” tag;

FIG. 16 is a diagram illustrating the first conversion processing in a case where there is a setting of scroll bar display;

FIG. 17 is a flowchart of second operation event invalidation processing;

FIG. 18 is a diagram illustrating second conversion processing in a case where there is the “iframe” tag;

FIG. 19 is a diagram illustrating the second conversion processing in a case where there is the setting of scroll bar display; and

FIG. 20 is a configuration diagram of an information processing device.

### DESCRIPTION OF EMBODIMENTS

Since the size of the screen of a mobile terminal device is limited, in a case where another scrollable content is embedded in a scrollable web page, it is hard to perform a scroll operation on the web page in some cases.

Such a problem arises not only in a scroll operation in the mobile terminal device but also in the case of performing a scroll operation in another information processing device such as a desktop-type personal computer (PC).

Hereinafter, an embodiment will be described in detail with reference to drawings. In the case of a mobile terminal device whose screen size is limited, if another scrollable content is embedded in a scrollable web page, a scroll operation on the web page may not be performed smoothly. In particular, in a case where the display area of the embedded content occupies most of the screen, it is difficult to scroll the web page.

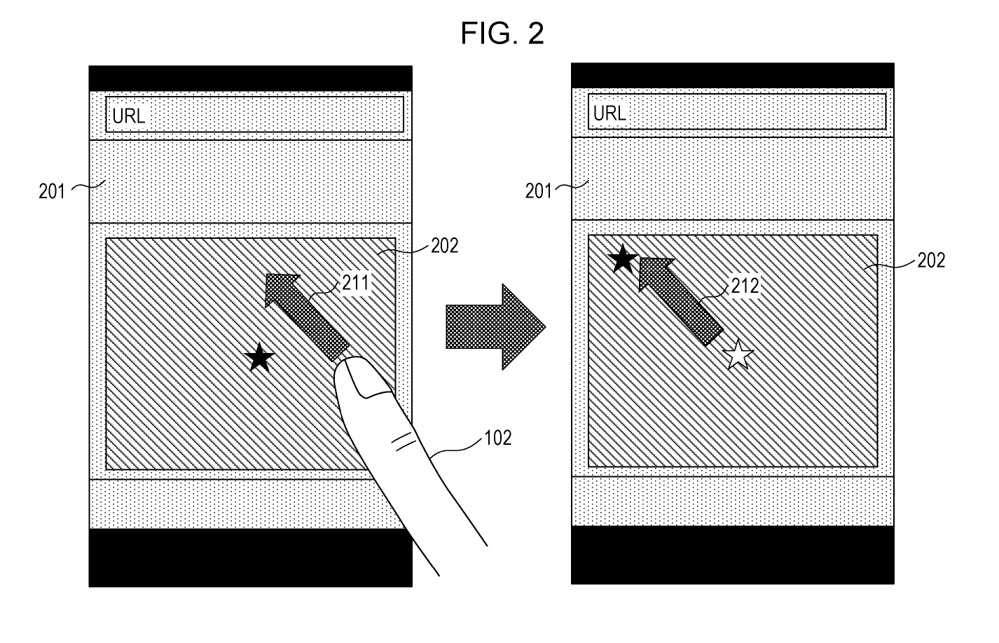

FIG. 2 illustrates an example of a content embedded in a web page. It is assumed that a map content 202 is embedded in a scrollable web page 201 and a user wants to browse other information in the web page 201 by scrolling the web page 201. At this time, in a case where the user's finger 102 accidentally touches the map content 202 and scrolls the map content 202 in the direction indicated by an arrow 211, as indicated by an arrow 212, the map content 202 is scrolled and the web page 201 is not scrolled.

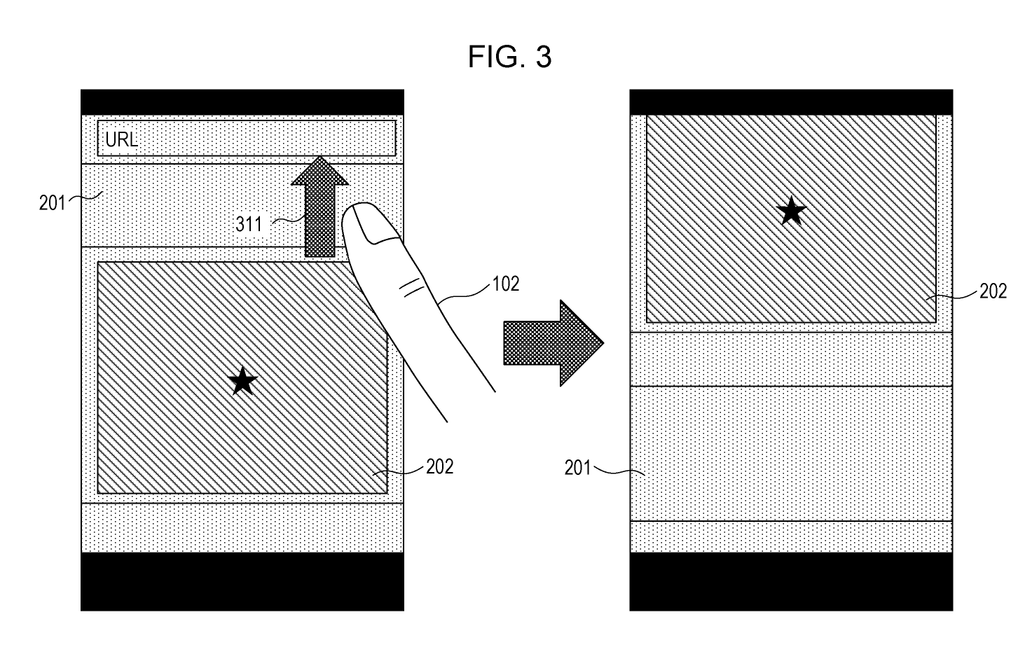

FIG. 3 illustrates an example of a scroll operation on the web page 201 in FIG. 2. In a case where the user scrolls the web page 201 with the finger 102 in the direction indicated by an arrow 311, the entire web page 201 including the map content 202 is scrolled upward, information on the lower side in the web page 201 is displayed on the screen. However, in a case where the size of the map content 202 occupies most of the screen, it is difficult to scroll the web page 201.

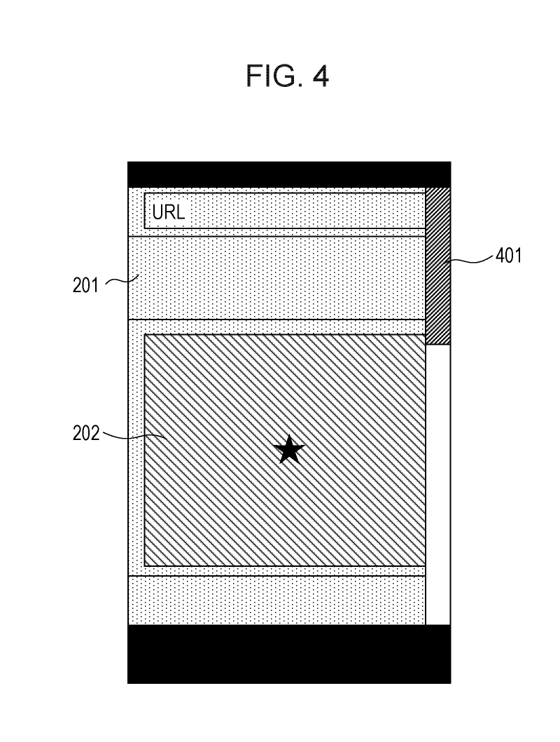

FIG. 4 illustrates an example of a display screen in which a scroll bar is added to the web page 201 in FIG. 2. In a case where a scroll bar 401 is added to the web page 201, the user may scroll up and down the entire web page 201 by using the scroll bar 401. However, since the scroll bar 401 has an elongated shape, it is desirable to carefully operate the scroll bar 401 on the screen of the mobile terminal device, and there is no guarantee that a smooth scroll operation is realized.

Therefore, it is conceivable to magnify and display the scroll bar 401. However, since the size of the screen of the mobile terminal device is limited, if the scroll bar 401 is enlarged and displayed, the display area of the web page 201 becomes narrow, making it difficult to see the web page 201 and the map content 202. In this way, it is difficult to achieve both the scroll operation on the web page 201 and the maximum display of the map content 202.

In order to solve this problem, a method of adding a trigger based on the following measurement to the browser is conceivable.

(a) Pressure Measurement

In a case where the user firmly presses the map content 202 in the web page 201, a scroll operation is performed on the map content 202, and in a case where the user softly presses the map content 202, a scroll operation is performed on the web page 201.

(b) Acceleration Measurement

In a case where the user quickly slides the map content 202 in the web page 201, a scroll operation is performed on the map content 202, and in a case where the user slowly slides the map content 202, a scroll operation is performed on the web page 201.

(c) Moving Amount Measurement

In a case where the user slides the map content 202 in the web page 201 to a large extent, a scroll operation is performed on the map contents 202, and in a case where the user slides the map content 202 to a small extent, a scroll operation is performed on the web page 201.

However, in any of the measurements (a) to (c), there is a possibility that information different from the user's intention will be scrolled depending on a threshold value for a measurement value.

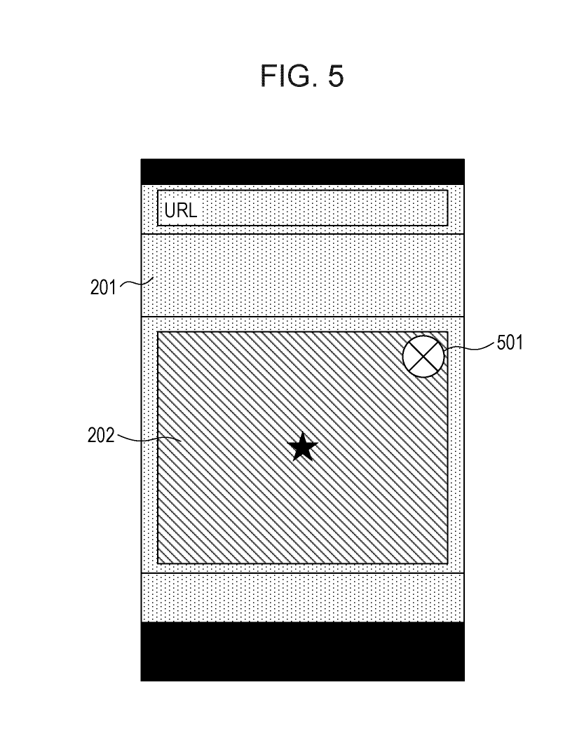

FIG. 5 illustrates an example of a display screen in which a non -display button is added to the map content 202 in FIG. 2. In this example, when the user presses a non-display button 501 displayed in the map content 202, the browser changes the map content 202 to a non-display state. As a result, the user may smoothly scroll the web page 201.

However, in a case where the map content 202 is displayed again, if the map content 202 occupies the screen, it is still difficult to perform a scroll operation on the web page 201. Therefore, it is difficult to return to the state of displaying the map content 202.

In addition, when the non-display button 501 is placed in the map content 202, part of the map content 202 is hidden. Furthermore, in the case of the mobile terminal device, there is no room to place the non-display button 501 in the toolbar of the browser, and if the non-display button 501 is placed in the menu displayed by a menu button, a selection operation becomes complicated.

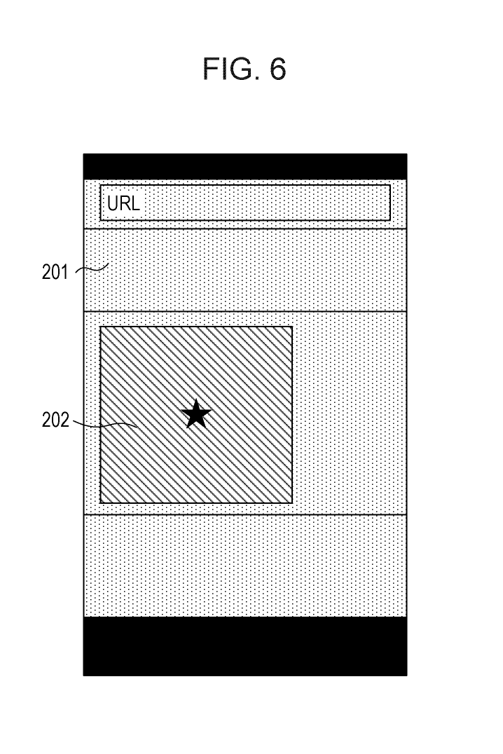

FIG. 6 illustrates an example of a display screen in which the size of the map content 202 in FIG. 2 is limited. By limiting the size of the map content 202 to a predetermined size or less and displaying the map content 202 small, the operable area of the web page 201 is widened. Therefore, it is easy to scroll the web page 201.

However, in the case of the mobile terminal device, if the map content 202 is displayed small, the visibility and operability of the map content 202 are deteriorated, and therefore the use thereof is restricted. In addition, a part of another content in the web page 201 may be displayed in a vacant area by reducing the map content 202 and the layout of the entire web page 201 may be lost. Furthermore, in a case where a plurality of scrollable contents are -side manner, and therefore there is a possibility that the operability of a scroll operation on the web page 201 does not change after all.

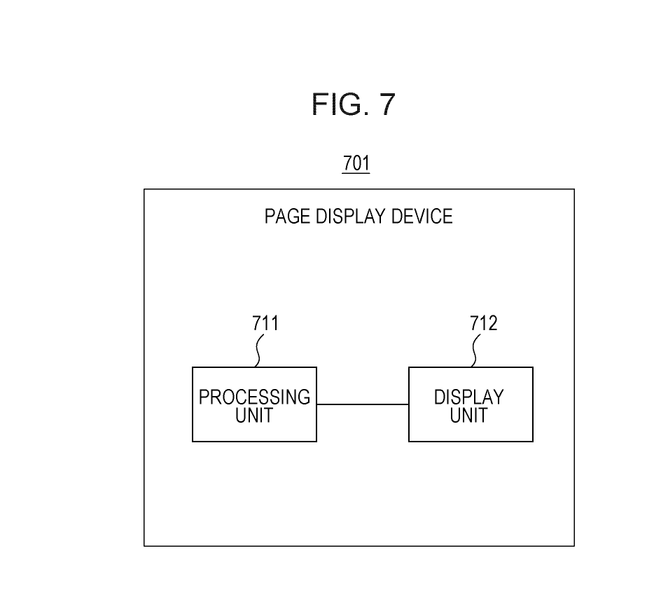

FIG. 7 illustrates a functional configuration example of a page display device of the embodiment. A page display device 701 in FIG. 2 includes a processing unit 711 and a display unit 712.

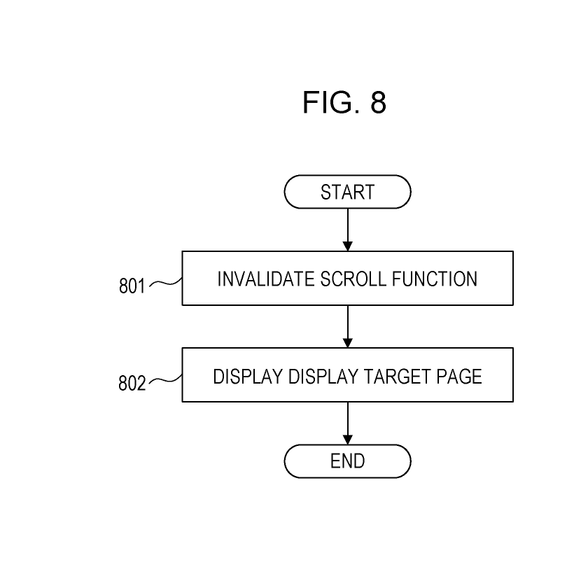

FIG. 8 is a flowchart illustrating an example of page display processing performed by the page display device 701 in FIG. 7. First, in a case where the content included in a display target page includes a scroll function for receiving a scroll operation on the content and the width or the height of the display area of the content or the ratio of the width or the height of the content to the screen displaying the display target page is in a predetermined state, the processing unit 711 invalidates the scroll function (operation 801). Then, the display unit 712 displays the display target page on the screen in a state of receiving an operation request for the content (operation 802).

According to such the page display device 701, in a case where a scrollable content is included in the display target page, it is possible to efficiently use the display target page and the content.

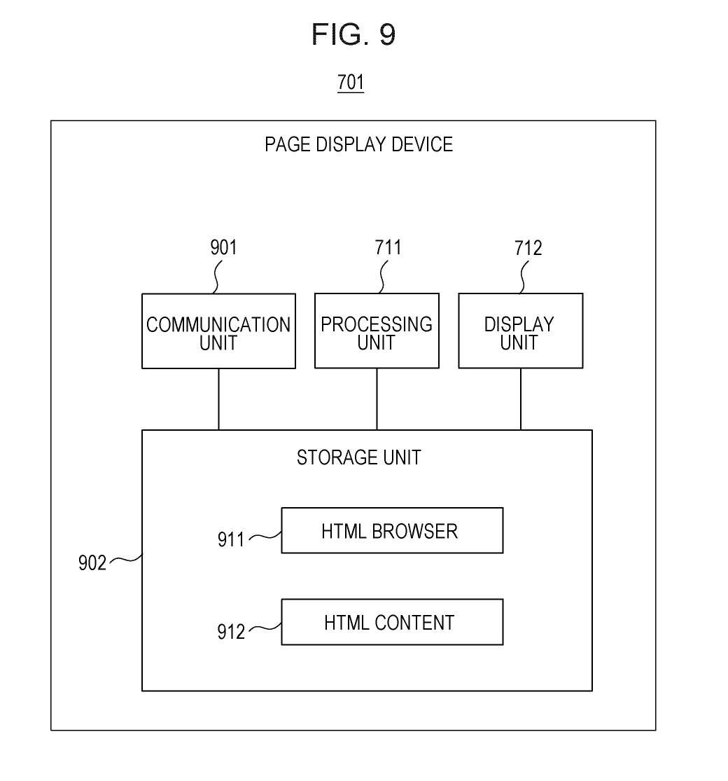

FIG. 9 illustrates a specific example of the page display device 701 in FIG. 7. The page display device 701 in FIG. 9 includes the processing unit 711, the display unit 712, a communication unit 901, and a storage unit 902. The storage unit 902 stores a HTML browser 911 and a HTML content 412. The page display device 701 may be a mobile terminal device such as a smartphone, a tablet, a car navigation device or the like, or may be a desktop PC or the like.

The processing unit 711 requests a HTML content 912 to an external server via a communication network by executing the HTML browser 911. The communication unit 901 receives the HTML content 912 from the external server via the communication network and stores the received HTML content 912 in the storage unit 902. Then, the processing unit 711 analyzes the HTML content 912, converts the HTML content 912 into Document Object Model (DOM) information, and visualizes the HTML content 912 based on the DOM information by executing the HTML browser 911.

The HTML content 912 is a scrollable content representing a display target page, and another scrollable content is included inside the HTML content 912. The HTML content 912 and the content included therein include a scroll function for receiving a scroll operation. In the following description, the scrollable content included in the HTML content 912 may be referred to as an internal content.

The processing unit 711 invalidates an operation event for the internal content having a size that hinders a scroll operation on the HTML content 912 by executing the HTML browser 911. As a result, an operation function including a scroll function of the internal content is invalidated. Then, the display unit 712 displays the display target page on the screen in a state of receiving an operation request for the internal content.

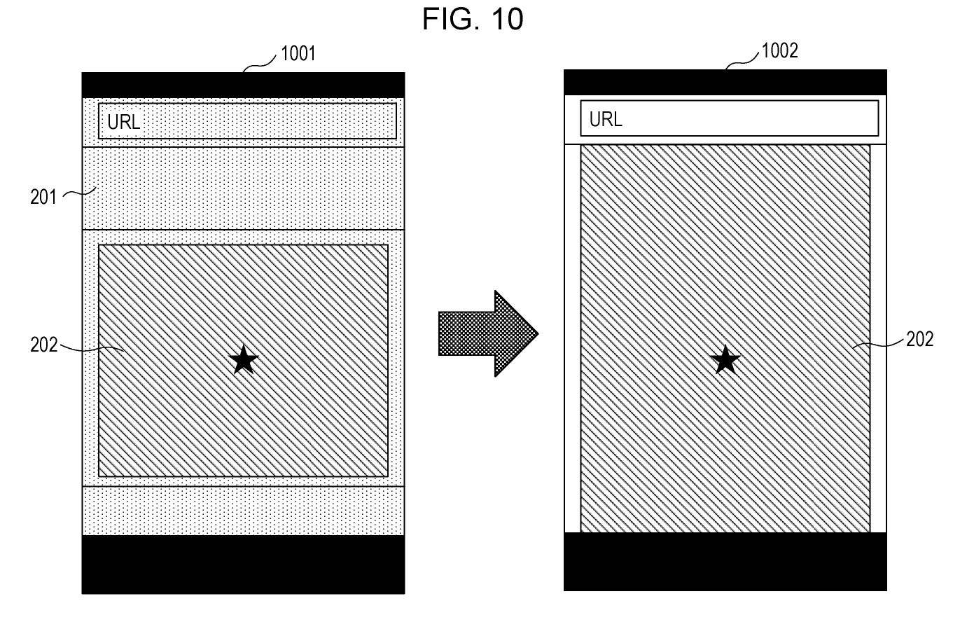

In a case where the web page 201 and the map content 202 in FIG. 2 are a display target page and an internal content, respectively, FIG. 10 illustrates an example of an operation of displaying the map content 202 on another page. In a case where the size of the map content 202 displayed on a screen 1001 is a predetermined size, the processing unit 711 invalidates the operation event for the map content 202. The predetermined size is a size that hinders a scroll operation on the web page 201 that is the display target page.

Since the operation event for the map content 202 is invalidated, even in a case where the user scrolls by touching the map content 202, the map content 202 is not scrolled. Therefore, in a case where the size of the map content 202 occupies most of the screen, the user may easily perform a scroll operation on the web page 201.

In a case where an operation request for the map content 202 is received from the user on the screen 1001, as illustrated on the screen 1002, the processing unit 711 displays the map content 202 on a page different from the web page 201. Then, the processing unit 711 validates an operation event for the map content 202 on the screen 1002. As a result, the user may perform a scroll operation on the map content 202 on another page. An operation request for the map content 202 on the screen 1001 may be a touch operation such as tap, double tap, long press, or the like.

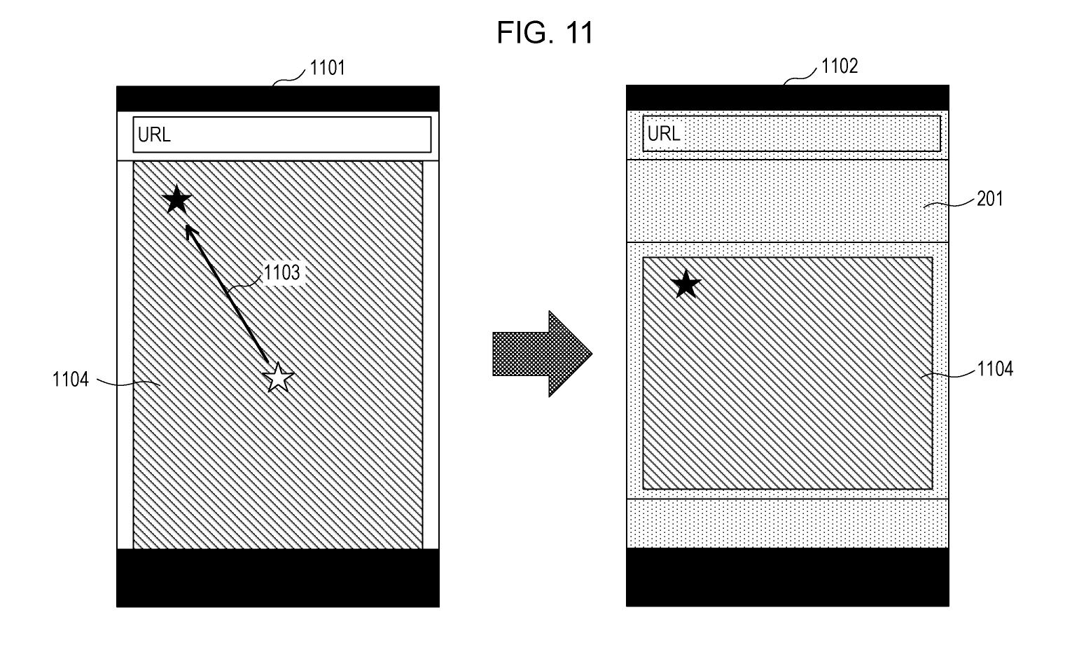

FIG. 11 illustrates an example of the operation of scrolling the map content 202 on the screen 1002 in FIG. 10. In a case where a scroll operation of scrolling the map content 202 in the direction indicated by an arrow 1103 is received on the screen 1002, as illustrated on the screen 1101, the processing unit 711 scrolls the map content 202 and displays the scrolled map content 1104.

Next, in a case where an operation of returning to the display of the web page 201 is received from the user on the screen 1101, as illustrated on the screen 1102, the map content 202 in the web page 201 is replaced with the map content 1104 after the scrolling, and the web page 201 is displayed. As a result, the user may view the scrolled map content 1104 together with the web page 201.

By the way, the processing unit 711 may determine whether or not the size of the internal content is a size that hinders the scroll operation on the HTML content 912 based on the width, the height, the area, or the like of the display area of the internal content. In addition, the processing unit 711 may determine whether or not the size of the internal content is a size that hinders the scroll operation on the HTML content 912 based on the ratio of the size of the internal content to the size of the screen.

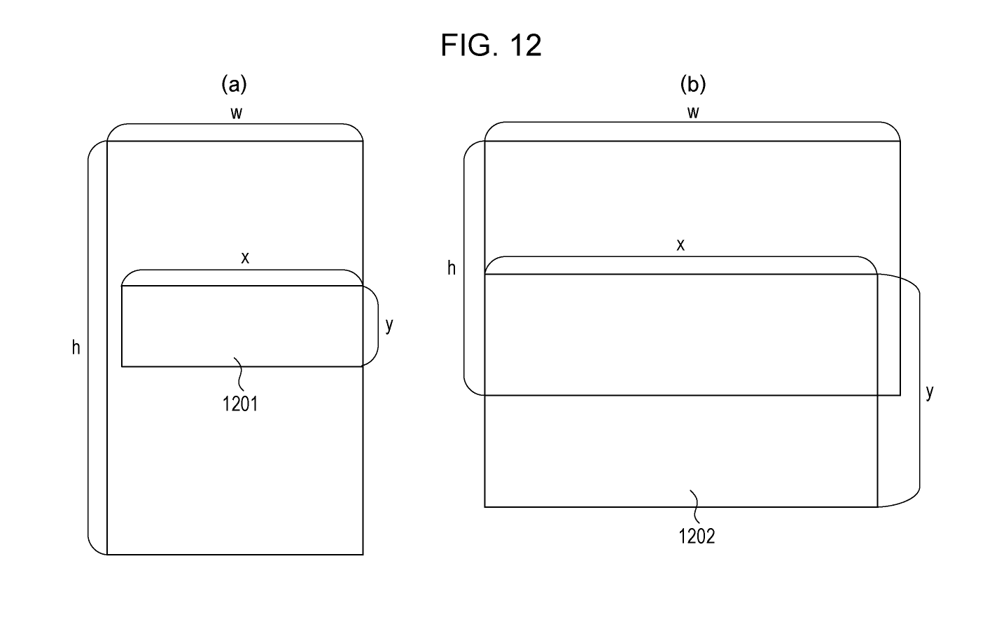

FIG. 12 illustrates an example of the sizes of the screen and internal content. FIG. 12(a) illustrates a case where the screen of the display unit 712 is a vertically elongated rectangle. The width and the height of the screen are w and h, respectively, and the width and height of the display area of the internal content 1201 are x and y, respectively. The size information indicating x and y is described in the HTML content 912.

On the other hand, FIG. 12(b) illustrates a case where the screen is a horizontally elongated rectangle. The width and height of the screen are w and h, respectively, and the width and height of the display area of the internal content 1202 are x and y, respectively. In this case, since the display area of the internal content 1202 does not fit within the screen, only a part of the internal content 1202 is displayed on the screen.

In a case where x and y satisfy one of the following conditions, the processing unit 711 may determine that the size of the internal content is a size that hinders the scroll operation on the HTML content 912.

(c1) x is larger than a predetermined value.

(c2) y is larger than a predetermined value.

(c3) x x y is larger than a predetermined value.

(c4) The ratio of x to w is larger than a predetermined value.

(c5) The ratio of y to h is larger than a predetermined value.

(c6) The ratio of x x y to w x h is larger than a predetermined value.

For example, in a case where a condition (c6) is applied to assume that the predetermined value is 40%, the ratio of the area of the internal content 1201 to the area of the screen in FIG. 12(a) is equal to or less than the predetermined value. Therefore, it is determined that the size of the internal content 1201 does not hinder the scroll operation on the HTML content 912.

On the other hand, the ratio of the area of the internal content 1202 to the area of the screen in FIG. 12(b) is larger than the predetermined value. Therefore, it is determined that the size of the internal content 1202 hinders the scroll operation on the HTML content 912.

The predetermined values in conditions (c1) to (c6) may be set by the user or may be set by the processing unit 711 by a predetermined algorithm. In a case where the size of internal content is changed by DOM information, each time the size of the HTML content 912 is changed, the processing unit 711 determines whether or not the changed size hinders the scroll operation on the HTML content 912.

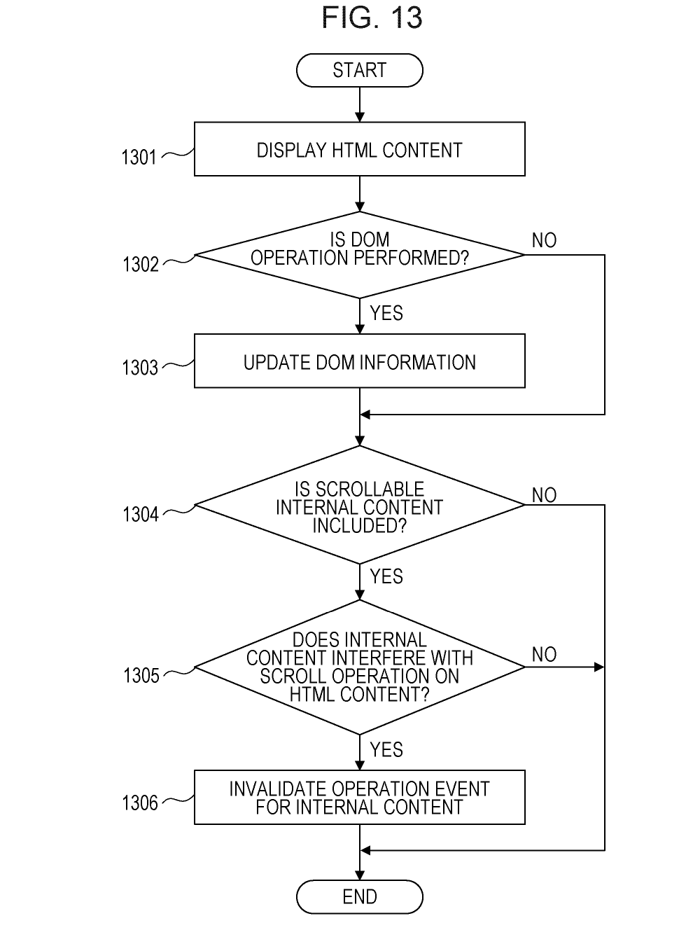

FIG. 13 is a flowchart illustrating a specific example of the page display processing performed by the page display device 701 in FIG. 9. The processing unit 711 executes the page display processing of FIG. 13 by executing the HTML browser 911.

First, the processing unit 711 displays the HTML content 912 on the screen as a display target page (operation 1301) and determines whether or not to perform a DOM operation by a script described in the HTML content 912 (operation 1302).

The script is described by, for example, an object-oriented script language, and the processing unit 711 may update the display information of the elements included in the DOM information by interpreting and executing the script. In a case where the elements included in the DOM information represents the internal content, the position and size of the internal content in the display target page may be changed by updating the display information. The script may be JavaScript (registered trademark).

In the case of executing the DOM operation by the script (YES in operation 1302), the processing unit 711 updates the DOM information according to the script (operation 1303). Then, the processing unit 711 analyzes the HTML content 912 and checks whether or not a scrollable internal content is included (operation 1304). For example, the processing unit 711 may

(p) There is an “iframe” tag indicating an inline frame of the internal content in the HTML content 912.

(q) In the HTML content 912, there is a tag of the internal content accompanied by a description such as “overflow: scroll” indicating the setting of scroll bar display.

In a case where a scrollable internal content is included in the HTML content 912 (YES in operation 1304), the processing unit 711 checks whether or not the internal content interferes with the scroll operation on the HTML content 912 (operation 1305). At this time, the processing unit 711 uses one of the conditions (c1) to (c6) to check whether or not the internal content hinders the scroll operation on the HTML content 912.

In a case where the internal content hinders the scroll operation on the HTML content 912 (YES in operation 1305), the processing unit 711 invalidates the operation event for the internal content (operation 1306).

In a case where a DOM operation by the script is not performed (NO in operation 1302), the processing unit 711 performs the processing in operation 1304 and subsequent operations. In a case where a scrollable internal content is not included in the HTML content 912 (NO in operation 1304), the processing unit 711 ends the processing. In addition, in a case where the internal content does not hinder the scroll operation on the HTML content 912 (No in operation 1305), the processing unit 711 ends the processing.

According to the page display processing of FIG. 13, every time the size of the internal content is changed by the DOM operation by the script, it is determined whether or not the changed size hinders the scroll operation on the HTML content 912. Therefore, even in a case where the size of the internal content is changed, it is possible to invalidate the operation event for the internal content based on the changed size.

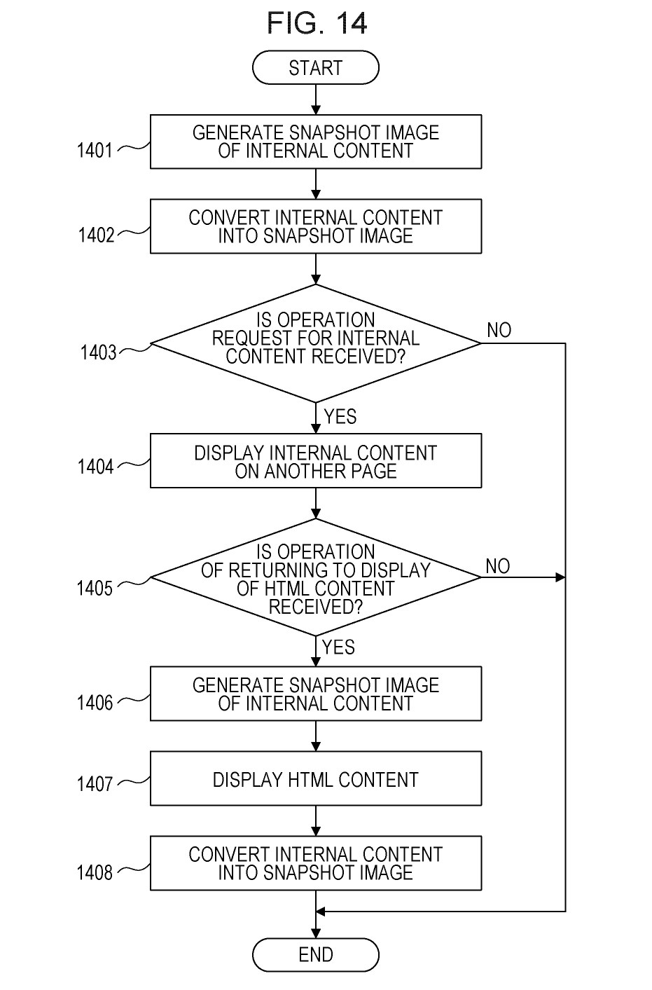

FIG. 14 is a flowchart of first operation event invalidation processing in operation 1306 of FIG. 13. First, the processing unit 711 generates a snapshot image of the internal content displayed in the HTML content 912 (operation 1401). Next, the processing unit 711 converts the internal content into a snapshot image on the screen and displays the snapshot image in a state of receiving an operation request for the internal content (operation 1402). Then, the processing unit 711 checks whether or not an operation request for the internal content is received from the user (operation 1403).

In a case where an operation request for the internal content is received (YES in operation 1403), the processing unit 711 displays the internal content on another page in a state in which the operation event is validated (operation 1404). As a result, the user may perform a scroll operation on the internal content on another page.

Next, the processing unit 711 checks whether or not an operation of returning to the display of the HTML content 912 is received from the user (operation 1405). In a case where an operation of returning to the display of the HTML content 912 (YES in operation 1405) is received, the processing unit 711 newly generates a snapshot image of the displayed internal content (operation 1406).

Next, the processing unit 711 displays the original HTML content 912, which was displayed before displaying another page, on the screen (operation 1407). Then, the processing unit 711 converts the internal content in the HTML content 912 into the newly generated snapshot image (operation 1408). In a case where a scroll operation on the internal content is performed on another page, the internal content after scrolling is displayed in the original HTML content 912.

In a case where an operation request for the internal content is not received (NO in operation 1403) or in a case where an operation of returning to the display of the HTML content 912 is not received (NO in operation 1405), the processing unit 711 ends the processing.

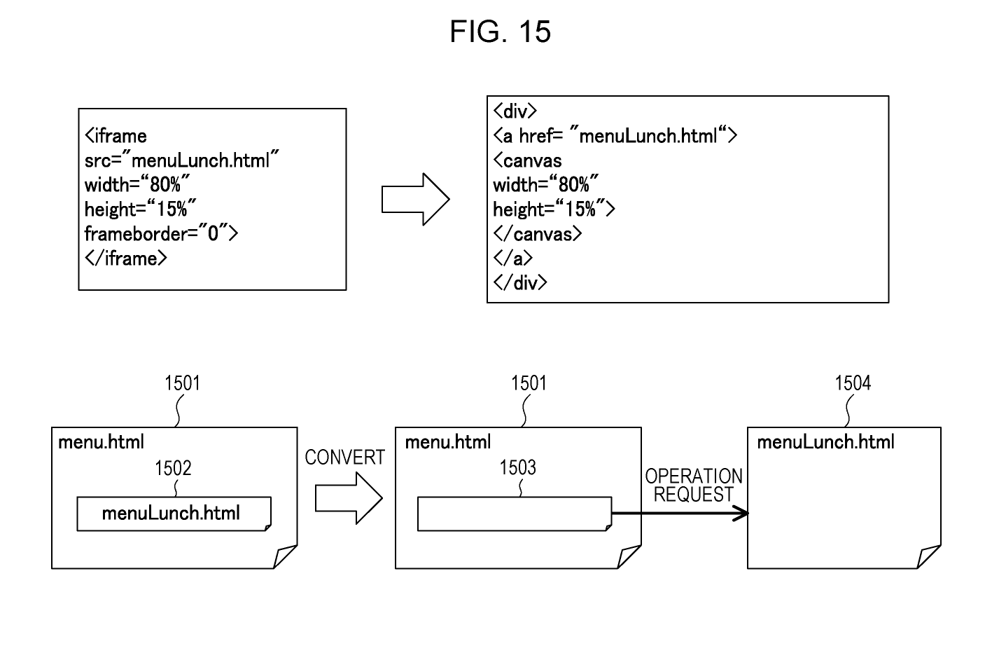

FIG. 15 illustrates first conversion processing in a case where there is an “iframe” tag of the internal content in the HTML content 912. In this example, an inline frame 1502 of a menuLunch.html representing the internal content is displayed in a screen 1501 of a menu.html representing the HTML content 912. There is an “iframe” tag in the menu.html, and the width and the height in the “iframe” tag are size information indicating the width and the height of the inline frame 1502, respectively.

width=“80%” indicates that the ratio of the width of the inline frame 1502 to the width of the screen 1501 is 80%, and height =“15%” indicates that the ratio of the height of the inline frame 1502 to the height of the screen 1501 is 15%.

In this case, in operation 1401, the processing unit 711 generates a snapshot image 1503 of the inline frame 1502. Next, in operation 1402, the processing unit 711 converts the “iframe” tag in the menu.html into the “canvas” tag, thereby converting the inline frame 1502 in the screen 1501 into the snapshot image 1503.

Then, the processing unit 711 adds an “a href” tag that defines the operation in the case of receiving an operation request for the snapshot image 1503. The menuLunch.html is specified as the link destination Uniform Resource Locator (URL) in the “a href” tag. As a result, in the case of receiving an operation request for the snapshot image 1503, the processing unit 711 may display the menuLunch.html on another page 1504.

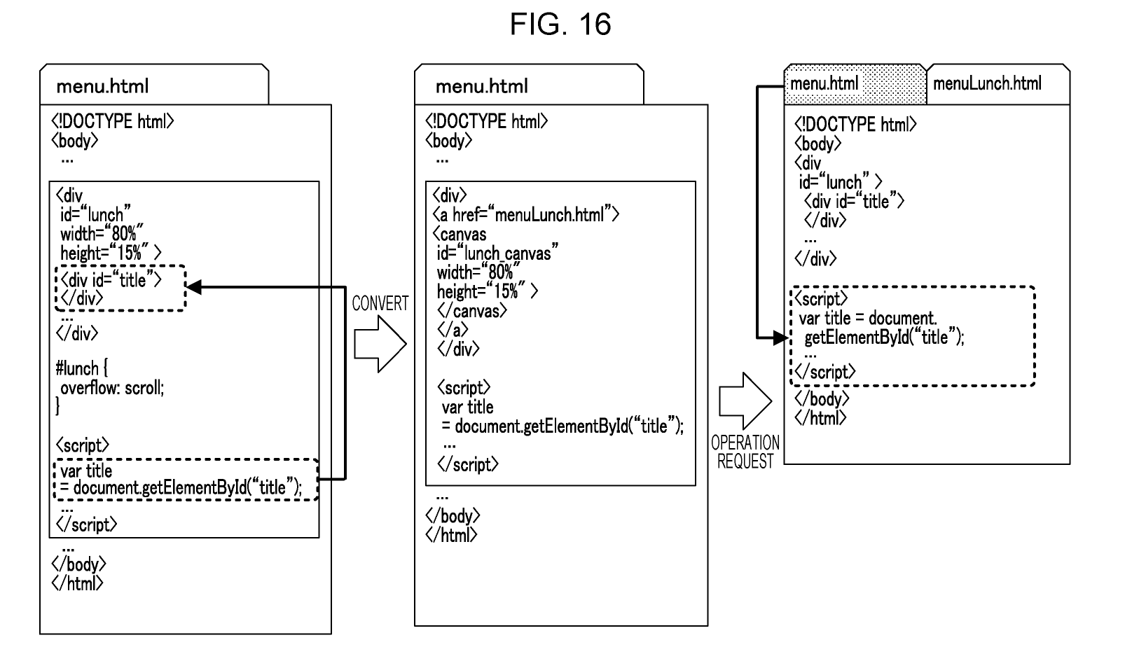

FIG. 16 illustrates the first conversion processing in a case where there is a tag of the internal content indicating the setting of scroll bar display in the HTML content 912. In this example, in the menu.html representing the HTML content 912, there are a “div” tag including id=“lunch” indicating the internal content and “overflow: scroll” indicating the setting of scroll bar display for the internal content. The width and height in the “div” tag are size information indicating the width and the height of the internal content, respectively.

In this case, in operation 1401, the processing unit 711 generates a snapshot image of a “div” tag in which id =“lunch” indicating the internal content is specified. Next, in operation 1402, the processing unit 711 converts the inside of the “div” tag into the “canvas” tag, thereby converting the “div” tag in which id=“lunch” is specified into the snapshot image. Then, the processing unit 711 creates a menuLunch.html that may refer to the “div” tag in which id=“lunch” is specified and the associated DOM information, and as in the case of FIG. 15, add the “a href” tag specifying the menuLunch.html as a link destination URL.

As a result, in the case of receiving an operation request for the snapshot image, the processing unit 711 may generate and display another page representing the menuLunch.html.

According to the operation event invalidation processing of FIG. 14, the scroll operation on the HTML content 912 may be invalidated by converting the internal content in the HTML content 912 into a snapshot image. In addition, it is possible to display the HTML content 912 without hindering the use of the internal content by displaying the snapshot image in a state of receiving an operation request for the internal content.

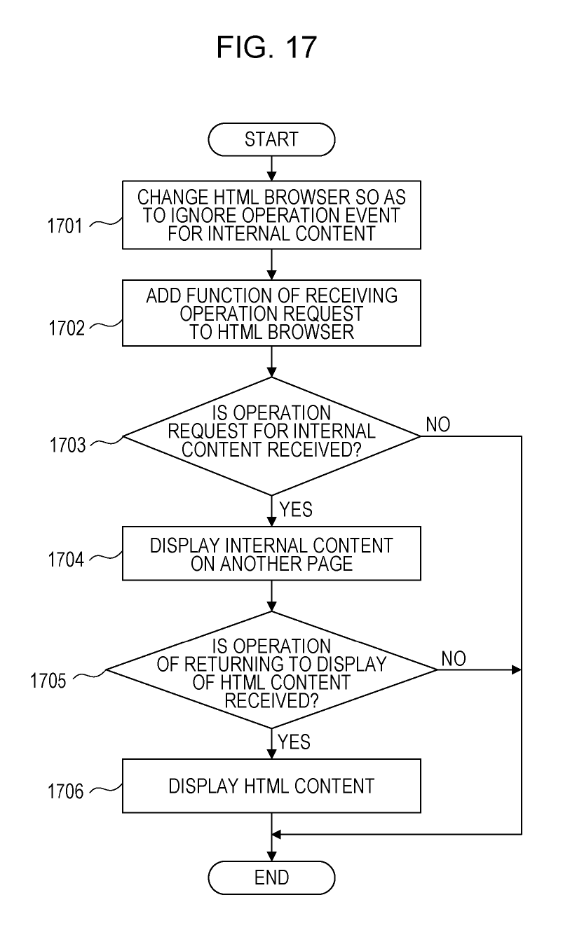

FIG. 17 is a flowchart of second operation event invalidation processing in operation 1306 of FIG. 13. First, the processing unit 711 changes the HTML browser 911 so as to ignore the operation event for the internal content included in the HTML content 912 (operation 1701). Next, the processing unit 711 adds a function of receiving an operation request for the internal content to the HTML browser 911 (operation 1702).

The processing of the next operation 1703 to operation 1705 is the same as the processing of operation 1403 to operation 1405 of FIG. 14. In a case where an operation of returning to the display of the HTML content 912 is received (YES in operation 1705), the processing unit 711 displays the original HTML content 912 displayed before displaying another page on the screen (operation 1706). In a case where a scroll operation on the internal content is performed on another page, the internal content after scrolling is displayed in the original HTML content 912.

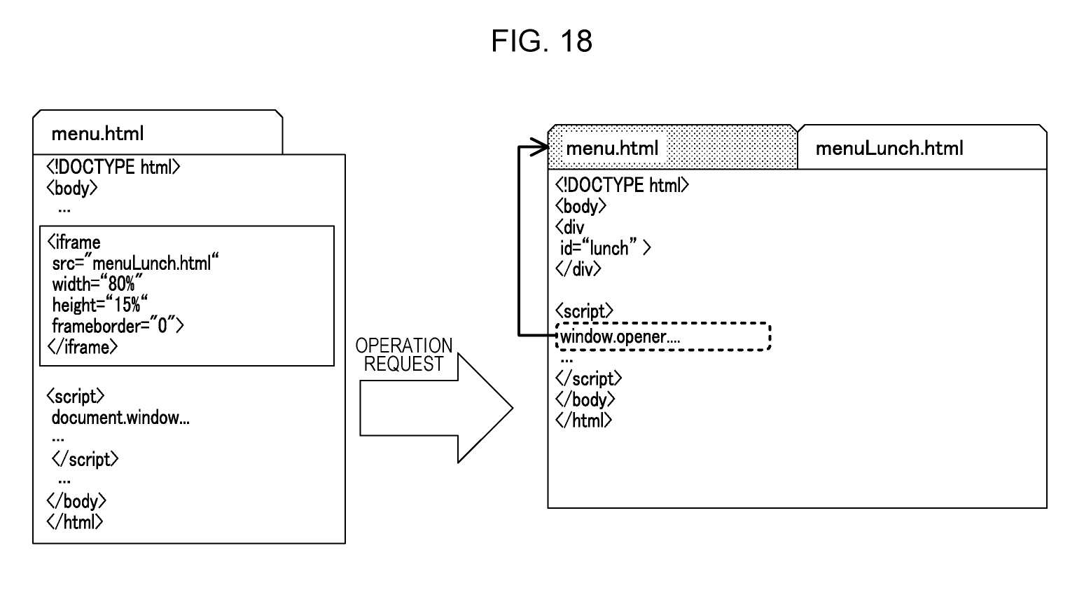

FIG. 18 illustrates second conversion processing in a case where there is an “iframe” tag of the internal content in the HTML content 912. In this example, there is an “iframe” tag of the menuLunch.html representing the internal content in the menu.html representing the HTML content 912. The width and height in the “iframe” tag are size information indicating the width and the height of the internal content, respectively.

In this case, in operation 1701, the processing unit 711 changes the HTML browser 911 so as to ignore the operation event (not illustrated) for the menuLunch.html described in the menu.html. Next, in operation 1702, the processing unit 711 adds a function of receiving an operation request for the menuLunch.html to the HTML browser 911.

As a result, in the case of receiving an operation request for the menuLunch.html, the processing unit 711 may generate and display another page representing the menuLunch.html. In the menuLunch.html, window.opener is described using a “script” tag. The processing unit 711 may return a reference to the DOM information to the menu.html by this window.opener.

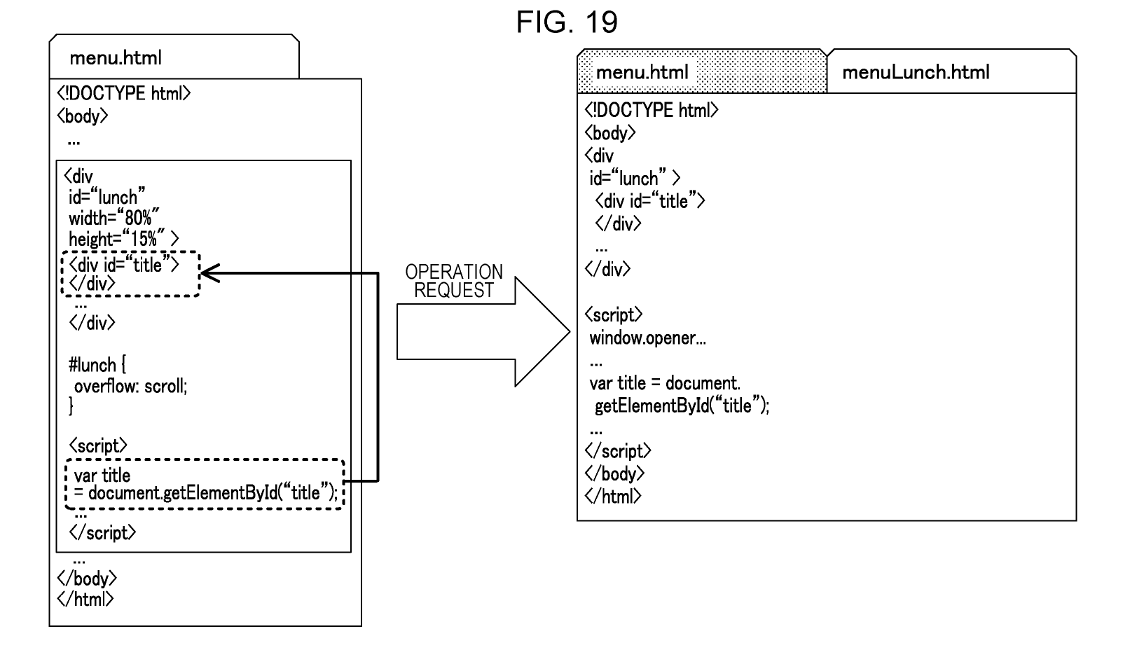

FIG. 19 illustrates the second conversion processing in a case where there is a tag of the internal content indicating the setting of scroll bar display in the HTML content 912. In this example, in the menu.html representing the HTML content 912, there are a “div” tag including id=“lunch” indicating the internal content and “overflow: scroll” indicating the setting of scroll bar display for the internal content. The width and height in the “div” tag are size information indicating the width and the height of the internal content, respectively.

In this case, in operation 1701, as in the case of FIG. 18, the processing unit 711 changes the HTML browser 911 so as to ignore the operation event (not illustrated) for the internal content described in the menu.html. Next, in operation 1702, the processing unit 711 adds a function of receiving an operation request for the internal content to the HTML browser 911.

As a result, in the case of receiving an operation request for the internal content, the processing unit 711 may generate and display another page representing the menuLunch.html. As in the case of FIG. 18, the processing unit 711 may return a reference to the DOM information to the menu.html by this window.opener in the menuLunch.html.

According to the operation event invalidation processing of FIG. 17, the scroll operation on the HTML content 912 may be invalidated by changing the HTML browser 911 so as to ignore the operation event for the internal content. In addition, it is possible to display the HTML content 912 without hindering the use of the internal content by adding the function of receiving an operation request for the internal content to the HTML browser 911.

The configuration of the page display device 701 in FIGS. 7 and 9 is merely an example, and some of the constituent elements may be omitted or changed according to the use or conditions of the page display device 701.

The flowcharts of FIGS. 8, 13, 14, and 17 are merely examples, and some processing may be omitted or changed depending on the configuration or conditions of the page display device 701. For example, in a case where the DOM operation by the script is not performed, the processing of operation 1302 and operation 1303 of FIG. 13 may be omitted.

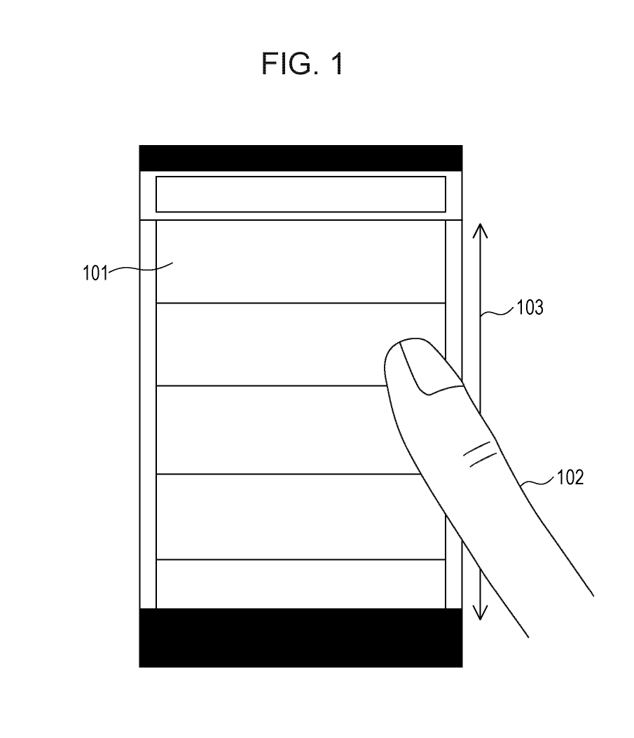

The display screens of FIGS. 1 to 6 and FIGS. 10 to 12 are merely examples, and the display screen changes according to the content to be displayed. The content to be displayed is not limited to the HTML content 912 and may be another content including an internal content, such as content described in eXtensible Markup Language (XML).

The HTML content 912 and the internal content in FIGS. 15, 16, 18, and 19 are merely examples, and the content to be displayed varies according to the use or conditions of the page display device 701.

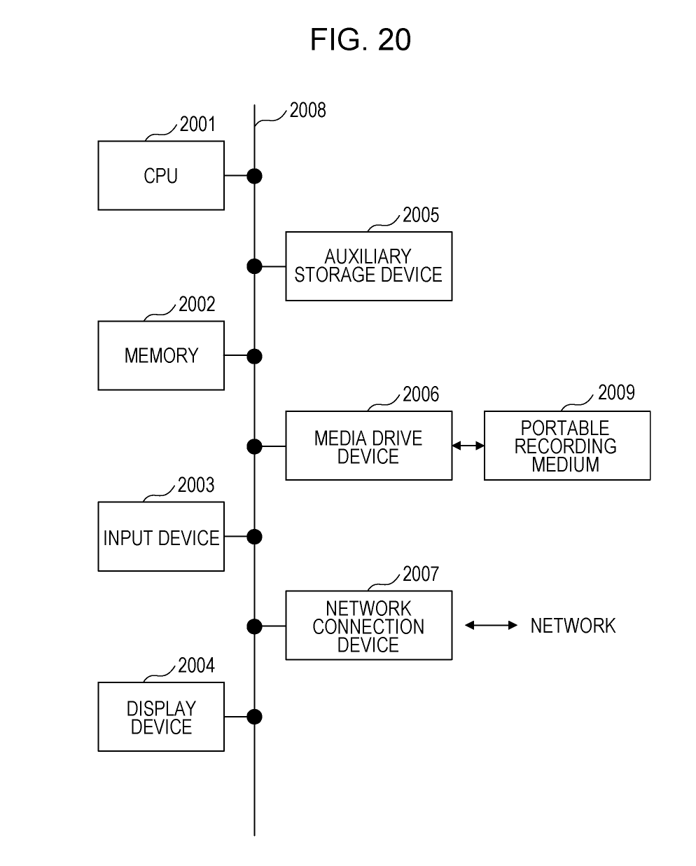

FIG. 20 illustrates a configuration example of an information processing device (computer) used as the page display device 701 in FIGS. 7 and 9. The information processing device in FIG. 20 includes a Central Processing Unit (CPU) 2001, a memory 2002, an input device 2003, a display device 2004, an auxiliary storage device 2005, a media drive device 2006, and a network connection device 2007. These components are connected to each other by a bus 2008.

The memory 2002 is, for example, a semiconductor memory such as a Read Only Memory (ROM), a Random Access Memory (RAM), a flash memory or the like, and stores a program and data used for page display processing. The memory 2002 may be used as the storage unit 902 in FIG. 9.

The CPU 2001 (processor) operates as the processing unit 711 in FIGS. 7 and 9, for example, by using the memory 2002 and executing a program.

The input device 2003 is, for example, a keyboard, a pointing device, or the like, and is used for inputting instructions or information from an operator or a user. In a case where the information processing device is a mobile terminal device, a touch panel may be used as the input device 2003. The display device 2004 is used for inquiring or instructions to an operator or a user and for outputting a processing result. The processing result may be the HTML content 912 or the internal content. The display device 2004 may be used as the display unit 712 in FIGS. 7 and 9.

The auxiliary storage device 2005 is, for example, a magnetic disk device, an optical disk device, a magneto-optical disk device, a tape device, or the like. The auxiliary storage device 2005 may be a hard disk drive or a flash memory. In a case where the information processing device is a mobile terminal device, a flash memory may be used as the auxiliary storage device 2005. The information processing device may store a program and data in the auxiliary storage device 2005 and load the program and data into the memory 2002 for use. The auxiliary storage device 2005 may be used as the storage unit 902 in FIG. 9.

The medium drive device 2006 drives a portable recording medium 2009 and accesses the recorded content. The portable recording medium 2009 is a memory device, a flexible disk, an optical disk, a magneto-optical disk, or the like. The portable recording medium 2009 may be a Compact Disk Read Only Memory (CD-ROM), a Digital Versatile Disk (DVD), a Universal Serial Bus (USB) memory, or the like. In a case where the information processing device is a mobile terminal device, a memory card may be used as the portable recording medium 2009. An operator or a user may store a program and data in the portable recording medium 2009 and load the program and data into the memory 2002 for use.

As described above, the computer readable recording medium for storing the program and data used for the page display processing is a physical (non-transitory) storage medium such as the memory 2002, the auxiliary storage device 2005, or the portable recording medium 2009.

The network connection device 2007 is a communication interface that is connected to a communication network such as a local area network, a wide area network, and the like and performs data conversion accompanying communication. The information processing device may receive a program and data from an external device via the network connection device 2007 and load the program and data into the memory 2002 for use. The network connection device 2007 may be used as the communication unit 901 in FIG. 9.

The information processing device does not necessarily include all the constituent elements in FIG. 20, and it is also possible to omit some constituent elements according to use or conditions. For example, in a case where the portable recording medium 2009 is not used, the medium drive device 2006 may be omitted.

In the case where the information processing device is a mobile terminal device, the information processing device may include a device for talking such as a microphone and a speaker.

While the disclosed embodiment and the advantages thereof have been described in detail, those skilled in the art may make various changes, additions, and omissions without departing from the scope of the invention as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable non-transitory recording medium storing a program that causes a computer to execute a procedure, the procedure comprising:
invalidating a scroll function for receiving a scroll operation on a content, in a case where the content included in a display target page includes the scroll function and a width or a height of a display area of the content or a ratio of the width or the height of the content to a screen displaying the display target page is in a predetermined state; and
displaying the display target page on the screen in a state of receiving an operation request for the content.

2. The computer-readable non-transitory recording medium according to claim 1, wherein the procedure invalidates the scroll function by converting the content into a snapshot image.

3. The computer-readable non-transitory recording medium according to claim 1, wherein the procedure invalidates the scroll function by ignoring the scroll operation described on the display target page.

4. The computer-readable non-transitory recording medium according to claim 1, wherein the procedure displays the content on a different page from the display target page and receives a scroll operation on the displayed content, in a case where the procedure receives the operation request for the content.

5. The computer-readable non-transitory recording medium according to claim 4, wherein the procedure replaces the content in the display target page with the scrolled content so as to display the display target page, in a case where the procedure receives an operation of returning to display of the different page to display of the display target page.

6. The computer-readable non-transitory recording medium according to claim 1, wherein the procedure determines that the width or the height of the display area or the ratio of the width or height of the content to the screen is in the predetermined state, based on a size of the content described on the display target page.

7. The computer-readable non-transitory recording medium according to claim 1, wherein, every time a size of the content is changed, the procedure determines whether or not the width or the height of the display area of the changed content or the ratio of the width or the height of the changed content to the screen is in the predetermined state.

8. A page display device comprising:
a memory; and
a processor coupled to the memory and the processor configured to:
invalidate a scroll function for receiving a scroll operation on a content, in a case where the content included in a display target page includes the scroll function and a width or a height of a display area of the content or a ratio of the width or the height of the content to a screen displaying the display target page is in a predetermined state, and
display the display target page on the screen in a state of receiving an operation request for the content.

9. The page display device according to claim 8, wherein the processor is configured to invalidate the scroll function by converting the content into a snapshot image.

10. A page display method comprising:
invalidating a scroll function for receiving a scroll operation on a content, in a case where the content included in a display target page includes the scroll function and a width or a height of a display area of the content or a ratio of the width or the height of the content to a screen displaying the display target page is in a predetermined state; and
displaying the display target page on the screen in a state of receiving an operation request for the content, by a processor.

11. The page display method according to claim 10, wherein the processor invalidates the scroll function by converting the content into a snapshot image.
